(19) United States
(12) Patent Application Publication
(10) Pub. No.: US 2025/0155058 A1
(43) Pub. Date: May 15, 2025

(54) ASSEMBLY FOR ALIGNING

(71) Applicant: Siemens Energy Global GmbH & Co. KG, Erlangen (DE)

(72) Inventors: Markus Dings, Brüggen (DE); Martin Thomalla, Kempen (DE)

(21) Appl. No.: 18/838,638

(22) PCT Filed: Jan. 19, 2023
(86) PCT No.: PCT/EP2023/051222

§ 371 Date: Aug. 15, 2024

(30) Foreign Application Priority Data
Feb. 25, 2022 (DE) 10 2022 201 985.7

(51) Int. Cl. F16L 23/00; F16L 23/18

(52) U.S. Cl. CPC F16L 23/003; F16L 23/18

(57) ABSTRACT

The invention relates to an assembly for aligning a first pipeline with a second pipeline, wherein: the first pipeline has a first-pipeline end having a first adjusting ring which has a cut-out extending along an axis, around which cut-out a ring material extends in a circumferential direction; the second pipeline has a second-pipeline end having a second adjusting ring which has a cut-out extending along an axis, around which cut-out a ring material extends in a circumferential direction; the first adjusting ring has a first abutment face; the second adjusting ring has a second abutment face; the first abutment face of the first adjusting ring contactingly faces the second abutment face of the second adjusting ring; the first abutment face forms a surface of a spherical washer; and the second abutment face forms a surface of the spherical washer which is complementary to the surface of the first abutment face.

### BACKGROUND

Pipelines are generally fastened to one another by means of flanges. Flanges within the meaning of the invention are also denoted as pipeline flanges. If flanges are mentioned in the present case, this is understood to mean exclusively pipeline flanges. Flanges serve for the tight, releasable connection of pipe sections. The contact pressure of the circular sealing surfaces of the flanges applied by means of flange screws onto a seal optionally located therebetween is important for the seal. The screws extend through bores into the flanges or the so-called flange sheets. Flanges are generally welded to a pipe end as a component of the pipeline. Flanges can also be provided on connecting components.

During the production of pipelines and the installation of connected machines it often results in a spatial offset of the pipelines to be joined together, for example due to welding distortion.

The compensation of such an offset conventionally requires a complex reworking operation or adjusting operation on site, generally under poor conditions, in particular without suitable machine tools. To some extent, transport costs, processing costs and time delays are further unplanned drawbacks.

The object of the invention is to simplify these operations.

### SUMMARY

The invention relates to an assembly for aligning a first pipeline with a second pipeline, wherein the first pipeline has a first pipeline end having a first adjusting ring which has a cut-out extending along an axis, around which cut-out a ring material extends in a circumferential direction, wherein the second pipeline has a second pipeline end having a second adjusting ring which has a cut-out extending along an axis, around which cut-out a ring material extends in a circumferential direction, wherein the first adjusting ring has a first abutment face, wherein the second adjusting ring has a second abutment face, wherein the first abutment face of the first adjusting ring is arranged opposite and in contact with the second abutment face of the second adjusting ring.

The invention further relates to a method for aligning a first pipeline with a second pipeline, wherein the first pipeline is configured with a first adjusting ring on a first pipeline end, wherein the second pipeline is configured with a second adjusting ring on a second pipeline end, wherein the first adjusting ring has a first abutment face, wherein the second adjusting ring has a second abutment face, wherein the first abutment face of the first adjusting ring is arranged opposite and in contact with the second abutment face of the second adjusting ring.

In order to be able to compensate in a simple and flexible manner for different types of offset phenomena between pipelines, an assembly of the type defined in the introduction having the additional features of the characterizing part of claim 1 is proposed in order to achieve the object according to the invention.

The shape deviations of the seal which result from manufacturing tolerances relative to the assembly of the sealing surfaces to one another can be compensated by the invention without further processing on site, wherein the design is very compact.

Manufacturing tolerances of process lines or pipelines generally and the resulting shape deviations of seals relative to the assembly of the sealing surfaces to one another can be compensated during assembly without further processing on site, wherein adjusting weld seams or adjusting rings which are difficult to machine are no longer required.

A further advantage of the invention is the force shunt of the sealing elements required for compressor applications. The invention always ensures a defined coupling of the force of the pipelines to be connected and thus ensures a defined introduction of force into equipment (for example compressors). A further advantage relative to adjusting weld seams is the absence of thermally induced distortion after the welding.

The invention provides to arrange at the ends of a first pipeline an adjusting ring, the contact surface thereof being shaped in a spherical manner relative to a second adjusting ring of a second pipeline. The geometric shape of the abutment faces corresponds to a spherical layer, wherein the term spherical disk is also used. A spherical layer, also called a spherical disk, is a part of a sphere which is cut out from two parallel planes. The curved surface part is called the spherical zone.

Due to the geometric shape of the abutment faces it is possible to compensate for an angular offset between two pipelines. In other words, the first pipeline can be inclined relative to the second pipeline by means of the adjusting rings, resulting in the compensation of an angular offset.

According to an embodiment, a third adjusting ring is arranged between the second adjusting ring and the second pipeline end of the second pipeline, said third adjusting ring having a cut-out extending along an axis, around which cut-out a ring material extends in a circumferential direction, wherein the second adjusting ring and the third adjusting ring are configured to be displaceable relative to one another.

As a result, spacings can be set and optimized between the pipelines in the longitudinal direction thereof. The spacing between the first pipeline end and the second pipeline end can be increased or reduced thereby.

In one embodiment, the first adjusting ring is configured integrally with the first pipeline. The first pipeline end can accordingly be configured such that the spherical abutment face is attached directly in the first pipeline.

In one embodiment, the first adjusting ring is configured as a separate adjusting ring which can be connected to the first pipeline. Thus the adjusting ring which is configured with the spherical abutment face can be connected to the first pipeline in a suitable manner, for example by a welding process.

In one embodiment, a first seal is arranged between the first adjusting ring and the second adjusting ring in the circumferential direction.

In one embodiment, the second adjusting ring has a thread, wherein the third adjusting ring also has a thread, wherein the second adjusting ring and the third adjusting ring are connected together via the thread.

A thread is a profiled indentation which runs continuously in a helical manner (i.e. as a helix) in a cylindrical inner or outer wall. This continuous recess is denoted as a thread turn on a screw or in a nut. It is a modification of the inclined plane, wherein a circumferential force is converted into a larger longitudinal force, for example in screw presses, wine presses and vehicle jacks. Components with external threads (screws) and those with internal threads (nuts) always form matching pairs.

The spacing between the first pipeline and the second pipeline can be varied by simply rotating the first pipeline or the first or second adjusting ring relative to the second pipeline or the third adjusting ring.

In one embodiment, the thread comprises a thread turn which extends over 360° in the circumferential direction.

In one embodiment, the thread turn is configured in a helical manner.

The above-described properties, features and advantages of this invention and the manner in which they are achieved will become clearer and more easily understandable in connection with the following description of exemplary embodiments which are explained in more detail in connection with the drawings.

Components which are the same or components having the same function are identified by the same reference signs.

Exemplary embodiments of the invention are described hereinafter with reference to the drawings. These drawings are not intended to show the exemplary embodiments to scale but where it is useful for the explanation the drawing is represented in schematic and/or slightly distorted form. With regard to additions to the teaching which can be directly identified in the drawing, reference is made to the relevant prior art.

### BRIEF DESCRIPTION OF THE DRAWINGS

FIG. 1 shows a schematic view of a first pipeline and a second pipeline in an optimal alignment.

FIG. 2 shows a schematic view of a first pipeline with an angular offset to a second pipeline.

FIG. 3 shows a schematic view of a first pipeline with a longitudinal offset to a second pipeline.

FIG. 4 shows a schematic view of a first pipeline and a second pipeline with a view of adjusting rings.

FIG. 5 shows a schematic side view of the adjusting rings.

FIG. 6 shows a schematic plan view of the adjusting rings.

FIG. 7 shows a schematic sectional view through the adjusting rings.

FIG. 8 shows a schematic sectional view through the adjusting rings with an angular offset.

FIG. 9 shows a schematic side view of the adjusting rings in a single view.

### DETAILED DESCRIPTION

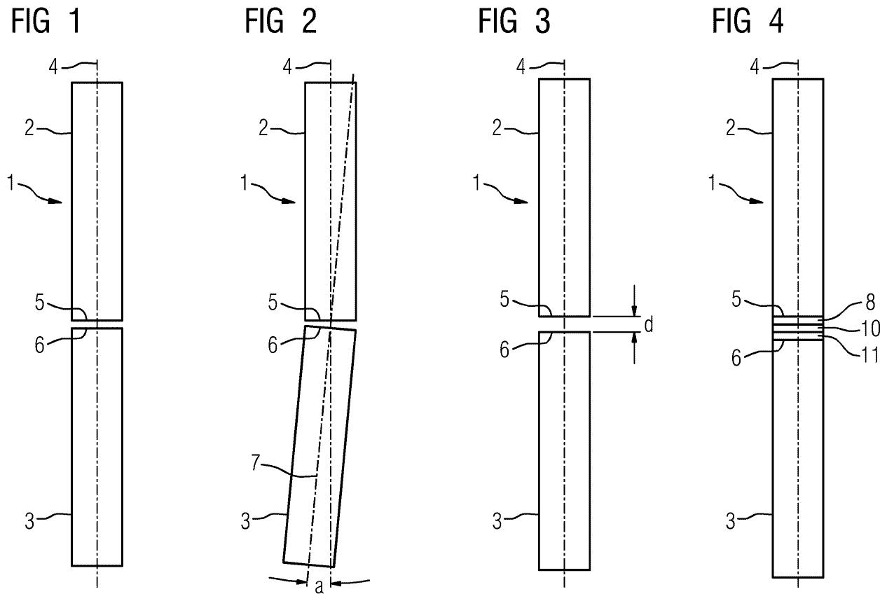

FIG. 1 shows a simple schematic view of an assembly 1 with a first pipeline 2 and a second pipeline 3, wherein the two pipelines 2, 3 extend along a common axis 4. During operation, a flow medium flows through the first and second pipeline 2, 3. An ideal position of the first and second pipeline 2, 3 is intended to be shown by FIG. 1, in which the two pipelines 2, 3 are arranged parallel to the axis 4. The two pipelines 2, 3 are connected together during operation and preferably flanges are used in order to connect the pipelines together.

The first pipeline 2 has a first pipeline end 5 at one end, wherein the second pipeline 3 has a second pipeline end 6 relative to the first pipeline end 5.

FIG. 2 shows a state in which the first pipeline 2 is inclined relative to the second pipeline 3 by an angle a. Such an assembly is necessary, for example, when assembling the pipelines 2, 3, since often a distortion or manufacturing tolerances are not optimally implemented. The second pipeline 3 extends along a further axis 7 which is inclined relative to the axis 4 at the angle a.

FIG. 3 shows in turn a state in which the first pipeline 2 is spaced apart relative to the second pipeline 3 by a distance d along the axis 4. This spacing is required, for example, when assembling the pipelines 2, 3, since often a distortion or manufacturing tolerances are not optimally implemented. The second pipeline 3 extends along the further axis 7 which is aligned parallel to the axis 4.

In practice, generally a combination of the state according to FIG. 2 and the state according to FIG. 3 is present. In other words: after installation the two pipelines have an offset at an angle a and a spacing d. An assembly is proposed by means of the invention by which the two pipelines 2, 3 can be connected together in spite of the offset at the angle a and the spacing d. This is achieved by an assembly which is shown in FIG. 4.

Accordingly, the assembly 1 has a first pipeline 2, wherein the first pipeline 2 has a first pipeline end 5 with a first adjusting ring 8 which has a cut-out (not shown in FIG. 4) extending along an axis 4, around which cut-out a ring material extends in a circumferential direction 9.

The assembly 1 also has a second pipeline 3 with a second pipeline end 6 with a second adjusting ring 10 which has a cut-out (not shown in FIG. 4) extending along the axis 4, around which cut-out a ring material extends in a circumferential direction 9.

The assembly 1 according to FIG. 4 has a further third adjusting ring 11 which is explained in more detail hereinafter.

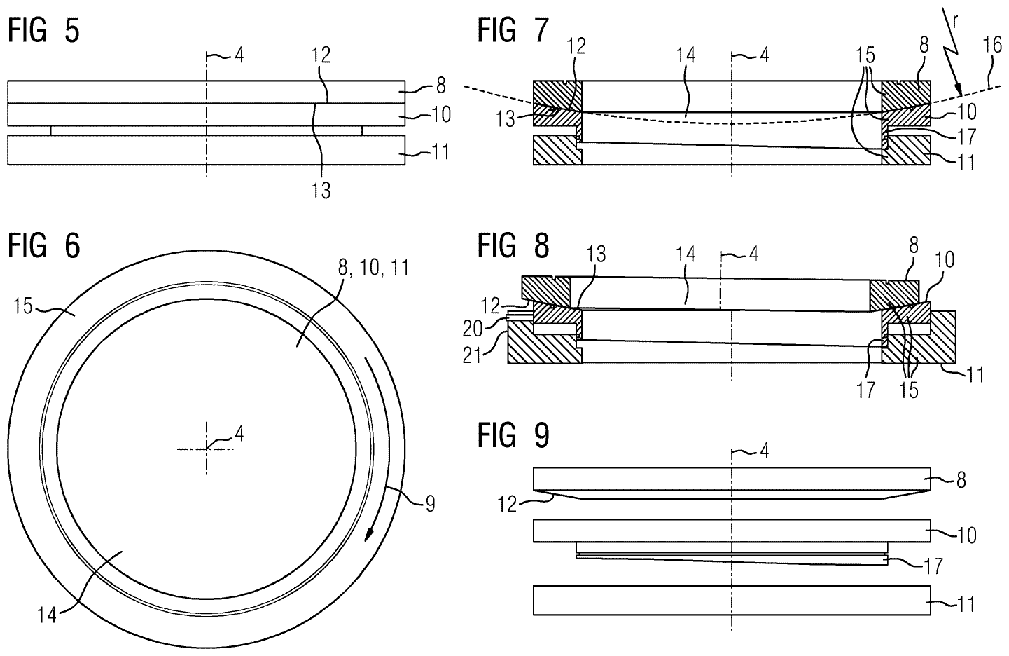

It is possible to adjust an offset at an angle a and a spacing d between the first pipeline 2 and the second pipeline 3 by means of the adjusting rings 8, 10, 11, which is now explained with the aid of FIGS. 5 to 9.

FIG. 5 shows a side view of the three adjusting rings 8, 10, 11. The first adjusting ring 8 has a first abutment face 12, wherein the second adjusting ring 10 has a second abutment face 13, wherein the first abutment face 12 of the first adjusting ring 8 is arranged opposite and in contact with the second abutment face 13 of the second adjusting ring 10.

FIG. 6 shows a view from above of the three adjusting rings 8, 10, 11. The adjusting rings 8, 10, 11 have a cut-out 14 extending along the axis 4, around which cut-out a ring material 15 extends in the circumferential direction 9.

FIGS. 7 and 8 show a sectional view through the three adjusting rings 8, 10, 11. FIG. 7 indicates the state in which the first pipeline 2 does not have an offset relative to the second pipeline 3 at an angle (angle a=0). FIG. 8 indicates the state in which the first pipeline 2 has an offset relative to the second pipeline 3 at an angle (angle a=ca. 3°).

The first abutment face 12 of the first adjusting ring 8 corresponds here to the geometric shape of a surface of a spherical disk. A spherical disk is a part of a sphere. In FIG. 7 the spherical shape is intended to be shown by the auxiliary line 16, wherein the auxiliary line is intended to represent a part of a sphere with the radius r.

The second abutment face 13 has a surface of the spherical disk which is configured in a complementary manner to the surface of the first abutment face 12. As a result, the first adjusting ring 8 can be rotated relative to the second adjusting ring 10 by the radius r, wherein the two abutment faces 12, 13 remain in contact.

FIG. 8 shows this state in which the second adjusting ring 10 is slightly rotated relative to the first adjusting ring 8. The abutment faces 12, 13 are in contact due to the geometric shape.

In a first embodiment, the first adjusting ring 8 is configured integrally with the first pipeline 2. In an alternative embodiment, the first adjusting ring 8 is configured as a separate adjusting ring 2 which can be connected to the first pipeline 2.

A seal is arranged between the first and second adjusting ring 2, 3 in the circumferential direction in order to improve the sealing action between the first adjusting ring 2 and the second adjusting ring 3.

A third adjusting ring 11 is arranged in order to compensate for an offset in the direction of the axis 4. A third adjusting ring 11 is arranged between the second adjusting ring 10 and the second pipeline end 6 of the second pipeline 3, said third adjusting ring having a cut-out 14 extending along the axis 4, around which cut-out a ring material 15 extends in the circumferential direction 9, wherein the second adjusting ring 10 and the third adjusting ring 11 are configured to be displaceable relative to one another. This is achieved by the second adjusting ring 10 having a thread 17, wherein the third adjusting ring 11 has a thread 17, wherein the second adjusting ring 10 and the third adjusting ring 11 are connected together via the thread 17. Thus a spacing between the second adjusting ring 10 and the third adjusting ring 11 is varied by rotating the second adjusting ring 10 relative to the third adjusting ring 11.

In a first embodiment, the third adjusting ring 11 is configured integrally with the second pipeline 3. In an alternative embodiment, the third adjusting ring 11 is configured as a separate adjusting ring 11 which can be connected to the second pipeline 3.

In one embodiment, the thread 17 is configured with a thread turn which extends over 360° in the circumferential direction.

FIG. 8 also shows a variant in which an axial securing device is installed. The axial securing device serves to connect together the second adjusting ring 10 and the third adjusting ring 11 after the alignment. The axial securing device is implemented via an overhang 21 on the third adjusting ring 11 which is designed such that it bears against the second adjusting ring 10, wherein a displacement perpendicular to the axis 4 is prevented. A pin 20, which is configured such that it exerts a continuous force from the overhang 21 onto the second adjusting ring 10, is arranged in this overhang 21. This can be implemented, for example, via a thread.

As can be seen in FIG. 9, the thread turn is configured in a helical manner.

During the assembly of the first pipeline 2 with the second pipeline 3, the angular offset and the spacing are compensated by means of the adjusting rings 8, 10, 11. After this step, the adjusting rings 8, 10, 11 are connected together by a material connection. The material connection can be carried out by welding.

1. An assembly for aligning a first pipeline with a second pipeline,
wherein the first pipeline has a first pipeline end having a first adjusting ring which has a cut-out extending along an axis, around which cut-out a ring material extends in a circumferential direction,
wherein the second pipeline has a second pipeline end having a second adjusting ring which has a cut-out extending along an axis, around which cut-out a ring material extends in a circumferential direction,
wherein the first adjusting ring has a first abutment face,
wherein the second adjusting ring has a second abutment face,
wherein the first abutment face of the first adjusting ring is arranged opposite and in contact with the second abutment face of the second adjusting ring,
characterized in that
the first abutment face forms a surface of a spherical disk,
wherein the second abutment face forms a surface of the spherical disk which is configured in a complementary manner to the surface of the first abutment face,
wherein a third adjusting ring is arranged between the second adjusting ring and the second pipeline end of the second pipeline, said third adjusting ring having a cut-out extending along an axis, around which cut-out a ring material extends along a circumferential direction,
wherein the second adjusting ring and the third adjusting ring are configured to be displaceable relative to one another.

2. The assembly as claimed in claim 1,
wherein the first adjusting ring is configured integrally with the first pipeline.

3. The assembly as claimed in claim 1,
wherein the first adjusting ring is configured as a separate adjusting ring which can be connected to the first pipeline.

4. The assembly as claimed in claim 1,
wherein the third adjusting ring is configured integrally with the second pipeline.

5. The assembly as claimed in claim 1,
wherein the third adjusting ring is configured as a separate adjusting ring which can be connected to the second pipeline.

6. The assembly as claimed in claim 1,
wherein the second adjusting ring has a thread,
wherein the third adjusting ring has a thread,
wherein the second adjusting ring and the third adjusting ring are connected together via the thread.

7. The assembly as claimed in claim 6,
wherein the thread comprises a thread turn which extends over 360° in the circumferential direction.

8. The assembly as claimed in claim 6,
wherein the thread turn is configured in a helical manner.

9. A method for aligning a first pipeline with a second pipeline,
wherein the first pipeline is configured with a first adjusting ring on a first pipeline end,
wherein the second pipeline is configured with a second adjusting ring on a second pipeline end,
wherein the first adjusting ring has a first abutment face,
wherein the second adjusting ring has a second abutment face, the method comprising:
arranging the first abutment face of the first adjusting ring opposite and in contact with the second abutment face of the second adjusting ring,
wherein the first abutment face forms a surface of a spherical disk,
configuring the second abutment face forms a surface of the spherical disk in a complementary manner to the surface of the first abutment face;
compensating for an angular offset between the first pipeline relative to the second pipeline by a displacement of the first adjusting ring relative to the second adjusting ring along the surface of the spherical disk,
wherein the second pipeline is configured with a third adjusting ring; and
arranging the second adjusting ring and the third adjusting ring to be in contact with one another,
wherein the second adjusting ring and the third adjusting ring are configured to be displaceable relative to one another.

10. The method as claimed in claim 9,
wherein a seal is arranged between the first adjusting ring and the second adjusting ring in a circumferential direction.

11. The method as claimed in claim 9,
wherein after a rotation the first adjusting ring is joined to the second adjusting ring by a material connection.

12. The method as claimed in claim 9,
wherein the third adjusting ring and the second adjusting ring are connected together by a thread.

13. The method as claimed in claim 12,
wherein the thread is configured with a thread turn which extends over 360° in a circumferential direction.

14. The method as claimed in claim 12,
wherein the thread is configured in a helical manner.
